(19) United States
(12) Patent Application Publication
(10) Pub. No.: US 2026/0159366 A1
(43) Pub. Date: Jun. 11, 2026

(54) SYSTEM AND METHOD FOR PICKING INDUSTRIAL INFRASTRUCTURE FROM DYNAMICALLY SIZED STACKS

(71) Applicant: Seegrid Corporation, Pittsburgh, PA (US)

(72) Inventors: John Spletzer, Osprey, FL (US); Tru Hoang, Monterey Park, CA (US); Austin Jensen, Morgan, UT (US); Sean P. Kelly, West Chester, PA (US)

(21) Appl. No.: 19/413,272

(22) Filed: Dec. 9, 2025

Related U.S. Application Data
(60) Provisional application No. 63/729,527, filed on Dec. 9, 2024.

(51) Int. Cl. B66F 9/06; B66F 9/075; B66F 9/24

(52) U.S. Cl. CPC B66F 9/063; B66F 9/0755; B66F 9/24

(57) ABSTRACT

A robotic vehicle, such as an autonomous mobile robot (AMR), is provided, comprising a chassis; a navigation system configured to navigate the AMR to stacked infrastructures; at least one sensor including a payload presence sensor configured to perform a vertical scan of the stacked infrastructures; and at least one processor. The at least one processor is configured to estimate a height of the stacked infrastructures using data generated by the payload presence sensor and estimate a height of a target infrastructure using the estimated height of the stacked infrastructures and expected infrastructure heights.

### CROSS REFERENCE TO RELATED APPLICATIONS

The present application claims priority to U.S. Provisional Patent Application 63/729,527, filed Dec. 29, 2024, entitled, System and Method for Picking Industrial Infrastructure from Dynamically Sized Stacks, which is incorporated herein by reference.

The present application may be related to U.S. Provisional Appl. 63/885,501 filed on Sep. 22, 2025, entitled System and Method to Detect and Prevent Pushing of Industrial Infrastructure During Engagement; U.S. Provisional Appl. 63/817,586 filed on Jun. 4, 2025, entitled System and Method of Definition and Localization of Drop Zone Location; U.S. Provisional Appl. 63/430,184 filed on Dec. 5, 2022, entitled Just in Time Destination Definition and Route Planning; U.S. patent application Ser. No. 18/529,109, filed on Dec. 5, 2023, US Publication Number 2024/0184293, Published on Jun. 6, 2024, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution U.S. patent application Ser. No. 18/526,538, filed on Dec. 1, 2023, US Publication Number 2024/0185178, Published on Jun. 6, 2024, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. patent application Ser. No. 18/527,669, filed on Dec. 4, 2023, US Publication Number 2024/0182283, Published on Jun. 6, 2024, entitled Systems and Methods for Material Flow Automation; U.S. Provisional Appl. 63/430,174 filed on Dec. 5, 2022, entitled Process Centric User Configurable Step Framework for Composing Material Flow Automation; U.S. patent application Ser. No. 18/527,699, filed on Dec. 4, 2023, US Publication Number 2024/0181645, Published on Jun. 6, 2024, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. patent application Ser. No. 18/527,715, filed on Dec. 4, 2023, US Publication Number 2024/0184269, Published on Jun. 6, 2024, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. patent application Ser. No. 18/524,217, filed on Nov. 30, 2023, US Publication Number 2024/0182282, Published on Jun. 6, 2024, entitled Hybrid Autonomous System and Human Integration System and Method Logic; U.S. Provisional Appl. 63/430,180 filed on Dec. 5, 2022, entitled A System for Process Flow Templating and Duplication of Tasks Within Material Flow Automation; U.S. patent application Ser. No. 18/527,730, filed on Dec. 4, 2023, US Publication Number 2024/0184540, Published on Jun. 6, 2024, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); U.S. patent application Ser. No. 18/529,229, filed on Dec. 5, 2023, US Publication Number 2024/0184312, Published on Jun. 6, 2024, entitled A Method for Abstracting Integrations Between Industrial Controls and Autonomous Mobile Robots; and U.S. Provisional Appl. 63/430,170 filed on Dec. 5, 2022, entitled Visualization of Physical Space Robot Queuing Areas as Non Work Locations for Robotic Operations ; U.S. patent application Ser. No. 18/529,236, filed on Dec. 5, 2023, US Publication Number 2024/0184302, Published on Jun. 6, 2024, entitled Visualization of Physical Space Robot Queuing Areas as Non Work Locations for Robotic Operations, each of which is incorporated herein by reference in its entirety.

The present application may be related to U.S. Provisional Appl. 63/610,505 filed on Dec. 15, 2023, entitled Robotic Vehicle Forks-Engaged Sensor and Method of Using Same; U.S. patent application Ser. No. 18/975,477, filed Dec. 10, 2024, US Publication Number 2025/0197179, Published on Jun. 19, 2025, entitled Robotic Vehicle Forks-Engaged Sensor and Method of Using Same; U.S. Provisional Appl. 63/615,833 filed on Dec. 29, 2023, entitled Object Detection and Localization from Three-Dimensional (3S) Point Clouds Using Fixed Scale (FS) Images; U.S. patent application Ser. No. 19/000,867, filed Dec. 24, 2024, US Publication Number 2025/0218025, Published on Jul. 3, 2025, entitled Object Detection and Localization from Three-Dimensional (3S) Point Clouds Using Fixed Scale (FS) Images; U.S. Provisional Appl. 63/348,520 filed on Jun. 3, 2022, entitled System and Method for Generating Complex Runtime Path Networks from Incomplete Demonstration of Trained Activities; U.S. patent application Ser. No. 18/862,690, filed on Nov. 4, 2024, US Publication Number 2025/0348084, Published on Nov. 13, 2025, entitled System and Method for Generating Complex Runtime Path Networks from Incomplete Demonstration of Trained Activities; U.S. Provisional Appl. 63/410,355 filed on Sep. 27, 2022, entitled Dynamic, Deadlock-Free Hierarchical Spatial Mutexes Based on a Graph Network; U.S. patent application Ser. No. 18/373,544, filed on Sep. 27, 2023, US Publication Number 2024/0111585, Published on Apr. 4, 2024, entitled Shared Resource Management System and Method; U.S. Provisional Appl. 63/346483 filed on May 27, 2022, entitled System and Method for Performing Interactions with Physical Objects Based on Fusion of Multiple Sensors; U.S. patent application Ser. No. 18/862,699, filed on Nov. 4, 2024, US Publication Number 2025/0291362, Published on Sep. 18, 2025, entitled System and Method for Performing Interactions with Physical Objects Based on Fusion of Multiple Sensors; and U.S. Provisional Appl. 63/348,542 filed on Jun. 3, 2022, entitled Lane Grid Setup for Autonomous Mobile Robots (AMRs); U.S. patent application Ser. No. 18/849,310, filed on Sep. 20, 2024, US Publication Number 2025/0223142, Published on Jul. 10, 2025, entitled Lane Grid Setup for Autonomous Mobile Robot; U.S. Provisional Appl. 63/423,679, filed Nov. 8, 2022, entitled System and Method for Definition of a Zone of Dynamic Behavior with a Continuum of Possible Actions and Structural Locations within Same; U.S. patent application Ser. No. 18/504,927, filed on Nov. 8, 2023, US Publication Number 2024/0150159, Published on May 9, 2024, entitled System and Method for Definition of a Zone of Dynamic Behavior with a Continuum of Possible Actions and Structural Locations within Same; U.S. Provisional Appl. 63/423,683, filed Nov. 8, 2022, entitled System and Method for Optimized Traffic Flow Through Intersections with Conditional Convoying Based on Path Network Analysis; U.S. patent application Ser. No. 18/502,221, filed on Nov. 6, 2023, US Publication Number 2024/0152148, Published on May 9, 2024, entitled System and Method for Optimized Traffic Flow Through Intersections with Conditional Convoying Based on Path Network Analysis; U.S. Provisional Appl. 63/423,538, filed Nov. 8, 2022, entitled Method for Calibrating Planar Light-Curtain; U.S. patent application Ser. No. 18/503,451, filed on Nov. 7, 2023, US Publication Number 2024/0151837, Published on May 9, 2024, entitled Method for Calibrating Planar Light-Curtain; U.S. patent application Ser. No. 19/068,242, filed on Mar. 3, 2025, US Publication Number 2025/0199145, Published on Jun. 19, 2025, entitled Method and System for Calibrating Planar Light-Curtain; each of which is incorporated herein by reference in its entirety.

The present application may be related to U.S. Provisional Appl. 63/324,182 filed on Mar. 28, 2022, entitled A Hybrid, Context-Aware Localization System For Ground Vehicles; U.S. patent application Ser. No. 18/723,611, filed on Jun. 24, 2024, US Publication Number 2025/0059011, Published on Feb. 20, 2025, entitled A Hybrid, Context-Aware Localization System For Ground Vehicles; each of which is incorporated herein by reference in its entirety.

The present application may be related to U.S. Provisional Appl. 63/324,184 filed on Mar. 28, 2022, entitled Safety Field Switching Based On End Effector Conditions; U.S. patent application Ser. No. 18/838,795, filed on Aug. 15, 2024, US Publication Number 2025/0236498, Published on Jul. 24, 2025, entitled Safety Field Switching Based On End Effector Conditions In Vehicles; U.S. Provisional Appl. 63/324,185 filed on Mar. 28, 2022, entitled Dense Data Registration From a Vehicle Mounted Sensor Via Existing Actuator; U.S. patent application Ser. No. 18/842,163, filed on Aug. 28, 2024, US Publication Number 2025/0178874, Published on Jun. 5, 2025, entitled Dense Data Registration From a Vehicle Mounted Sensor; U.S. Provisional Appl. 63/324187 filed on Mar. 28, 2022, entitled Extrinsic Calibration of a Vehicle-Mounted Sensor Using Natural Vehicle Features; U.S. patent application Ser. No. 18/848,565, filed on Sep. 19, 2024, US Publication Number 2025/0218039, Published on Jul. 3, 2025, entitled Extrinsic Calibration of a Vehicle-Mounted Sensor Using Natural Vehicle Features; U.S. Provisional Appl. 63/324,188 filed on Mar. 28, 2022, entitled Continuous And Discrete Estimation Of Payload Engagement/Disengagement Sensing; U.S. patent application Ser. No. 18/846,359, filed on Sep. 12, 2024, US Publication Number 2025/0187884, Published on Jun. 12, 2025, entitled Continuous And Discrete Estimation Of Payload Engagement/Disengagement Sensing; U.S. Provisional Appl. 63/324,190 filed on Mar. 28, 2022, entitled Passively Actuated Sensor Deployment; U.S. patent application Ser. No. 18/285,030, filed on Sep. 29, 2023, US Publication Number 2024/0308825, Published on Sep. 19, 2024, entitled Passively Actuated Sensor System; U.S. patent application Ser. No. 19/053,708, filed on Feb. 14, 2025, US Publication Number 2025/0187886, Published on Jun. 12, 2025, entitled Passively Actuated Sensor System; U.S. Provisional Appl. 63/324,192 filed on Mar. 28, 2022, entitled Automated Identification of Potential Obstructions In A Targeted Drop Zone; U.S. patent application Ser. No. 18/723,598, filed on Jun. 24, 2024, US Publication Number 2025/0059010, Published on Feb. 20, 2025, entitled Automated Identification of Potential Obstructions In A Targeted Drop Zone; U.S. Provisional Appl. 63/324,193 filed on Mar. 28, 2022, entitled Localization of Horizontal Infrastructure Using Point Clouds; U.S. patent application Ser. No. 18/842,229, filed on Aug. 28, 2024, US Publication Number 2025/0181081, Published on Jun. 5, 2025, entitled Localization of Horizontal Infrastructure Using Point Clouds; U.S. Provisional Appl. 63/324,195 filed on Mar. 28, 2022, entitled Navigation Through Fusion of Multiple Localization Mechanisms and Fluid Transition Between Multiple Navigation Methods; U.S. patent application Ser. No. 18/849,629, filed on Sep. 23, 2024, US Publication Number 2025/0214817, Published on Jul. 3, 2025, entitled Robotic Vehicle Navigation with Dynamic Path Adjusting; U.S. Provisional Appl. 63/324,198 filed on Mar. 28, 2022, entitled Segmentation Of Detected Objects Into Obstructions And Allowed Objects; U.S. patent application Ser. No. 18/839,465, filed on Aug. 19, 2024, US Publication Number 2025/0162151, Published on May 22, 2025, entitled Segmentation Of Detected Objects Into Obstructions And Allowed Objects; U.S. Provisional Appl. 62/324,199 filed on Mar. 28, 2022, entitled Validating The Pose Of An AMR That Allows It To Interact With An Object; U.S. patent application Ser. No. 18/849,094, filed on Sep. 20, 2024, US Publication Number 2025/0230023, Published on Jul. 17, 2025, entitled Validating the Post of a Robotic Vehicle That Allows it to Interact with an Object on Fixed Infrastructure; and U.S. Provisional Appl. 63/324,201 filed on Mar. 28, 2022, entitled A System For AMRs That Leverages Priors When Localizing Industrial Infrastructure, U.S. patent application Ser. No. 18/852,369, filed on Sep. 27, 2024, US Publication Number 2025/0178872, Published on Jun. 5, 2025, entitled A System For AMRs That Leverages Priors When Localizing and Manipulating Industrial Infrastructure; each of which is incorporated herein by reference in its entirety.

The present application may be related to U.S. Design Patent Appl. 29/832,212, filed on Mar. 22, 2022, U.S. Design Pat. No. D1013000, Issued on Jan. 30, 2024, entitled Mobile Robot; UU.S. Design Patent Appl. 29/926,391, filed on Jan. 30, 2025, U.S. Design Pat. No. D1082879, Issued on Jul. 8, 2025, entitled Mobile Robot; U.S. Design Patent Appl. 30/010,206, filed on Jun. 26, 2025, U.S. Design Pat. No. D1105196, Issued on Dec. 9, 2025, entitled Mobile Robot; each of which is incorporated herein by reference in its entirety.

The present application may be related to U.S. patent application Ser. No. 17/478,338, filed on Sep. 17, 2021, U.S. Pat. No. 12,384,210, Issued on Aug. 12, 2025, entitled Mechanically-Adaptable Hitch Guide; U.S. patent application Ser. No. 19/264,931, filed on Jul. 10, 2025, US Publication Number 2025/0332874, Published on Oct. 30, 2025, entitled Mechanically-Adaptable Hitch Guide; each of which is incorporated herein by reference in its entirety.

The present application may be related to U.S. patent application Ser. No. 18/928,311, filed on Oct. 28, 2024, US Publication Number 2025/0076878, Published on Mar. 6, 2025, entitled Vehicle Object-Engagement Scanning System and Method; U.S. patent application Ser. No. 17/490,345, filed on Sep. 30, 2021, US Publication Number 2022/0100195, Published on Mar. 31, 2022,entitled Vehicle Object-Engagement Scanning System and Method; each of which is incorporated herein by reference in its entirety.

The present application may be related to U.S. patent application No. 17/197,516, filed on Mar. 10, 2021, U.S. Pat. No. 12,459,538, Issued on Oct. 22, 2025, entitled Self-Driving Vehicle Path Adaptation System and Method; U.S. patent application Ser. No. 19/359,139, filed on Oct. 15,2025, U.S. Publication No. ______, Published on ________, entitled Self-Driving Vehicle Path Adaptation System and Method; each of which is incorporated herein by reference in its entirety.

The present application may be related to U.S. patent application Ser. No. 18/748,777, filed on Jun. 20, 2024, US Publication Number 2024/0336154, Published on Oct. 10, 2024, entitled Vehicle Auto-Charging System and Method; each of which is incorporated herein by reference in its entirety.

The present application may be related to U.S. patent application Ser. No. 18/640,045, filed on Apr. 19, 2024, US Publication Number 2024/0262222, Published on Aug. 8, 2024, entitled Vehicle Auto-Charging System and Method; U.S. patent application Ser. No. 18/392,274, filed on Dec. 21, 2023, US Publication Number 2024/0239214, Published on Jul. 18, 2024, entitled Vehicle Auto-Charging System and Method; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 18/973,615, filed on Dec. 9, 2025, US Publication Number 2025/0100407, Published on Mar. 27, 2025, entitled Vehicle Auto-Charging System and Method; each of which is incorporated herein by reference in its entirety.

The present application may be related to U.S. patent application Ser. No. 18/199,052, filed on May 18, 2023, US Publication Number 2023/0376030, Published on Nov. 23, 2023, entitled Dynamic Allocation and Coordination of Auto-Navigating Vehicles and Selectors; U.S. patent application No. 16/892,549, filed on Jun. 4, 2020, US Publication Number 2020/0387154, Published on Dec. 10, 2020, entitled Dynamic Allocation and Coordination of Auto-Navigating Vehicles and Selectors; U.S. patent application Ser. No. 18/928,423, filed on Oct. 28, 2024, US Publication Number 2025/0050927, Published on Feb. 13, 2025, entitled Laterally Operating Payload Handling Device; each of which is incorporated herein by reference in its entirety.

The present application may be related to U.S. patent application Ser. No. 18/427,176, filed on Jan. 30, 2024, US Publication Number 2024/0246589, Published on Jul. 25, 2024, entitled Laterally Operating Payload Handling Device; U.S. patent application Ser. No. 17/712,660, filed on Apr. 4, 2022, U.S. Pat. No. 11,884,314, Issued on Jan. 30, 2024, entitled Laterally Operating Payload Handling Device; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 19/206,180, filed on May 13, 2025, US Publication Number 2025/0313,248, Published on Oct. 9, 2025, entitled Laterally Operating Payload Handling Device; U.S. patent application Ser. No. 14/196,147, filed on Mar. 4, 2014, U.S. Pat. No. 9,965,856, Issued on May 8, 2018, entitled Ranging Cameras Using a Common Substrate; each of which is incorporated herein by reference in its entirety.

The present application may be related to U.S. Design Patent Appl. 29/471,328, filed on Oct. 30, 2013, U.S. Pat. No. D730,847, Issued on Jun. 2, 2015, entitled Vehicle Interface Module; U.S. Design Patent Appl. 29/398,127, filed on Jul. 26, 2011, U.S. Pat. No. D680,142, Issued on Apr. 16, 2013, entitled Multi-Camera Head; each of which is incorporated herein by reference in its entirety.

The present application may be related to U.S. patent application Ser. No. 13/168,639, filed on Jun. 24, 2011, U.S. Pat. No. 8,864,164, Issued on Oct. 21, 2014, entitled Tugger Attachment; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; each of which is incorporated herein by reference in its entirety.

The present application may be related to U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137,Issued on Mar. 6, 2018, entitled System and Method Using A Multi-Plane Curtain; each of which is incorporated herein by reference in its entirety.

The present application may be related to U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/361,379, filed on Jan. 28, 2009, U.S. Pat. No. 8,433,442, Issued on Apr. 30, 2013, entitled Methods for Repurposing Temporal-Spatial Information Collected by Service Robots; each of which is incorporated herein by reference in its entirety.

The present application may be related to U.S. patent application Ser. No. 14/487,860, filed on Sep. 16, 2014, U.S. Pat. No. 9,603,499, Issued on Mar. 28, 2017, entitled Service Robot and Method Of Operating Same; U.S. patent application Ser. No. 12/361,441, filed on Jan. 28, 2009, U.S. Pat. No. 8,838,268, Issued on Sep. 16, 2014, entitled Service Robot and Method of Operating Same; U.S. patent application Ser. No. 12/361,300 filed on Jan. 28, 2009, U.S. Pat. No. 8,892,256, Issued on Nov. 18, 2014, entitled Methods for Real-Time and Near-Real Time Interactions with Robots That Service a Facility; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; each of which is incorporated herein by reference in its entirety.

The present application may be related to U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; each of which is incorporated herein by reference in its entirety.

### FIELD OF INTEREST

The present inventive concepts relate to systems and methods in the field of autonomous mobile robot (AMR) and/or robotic vehicles. In particular, the inventive concepts may be related to systems and methods in the field of detection and localization of infrastructure, which can be implemented by or in an autonomous mobile robot (AMR).

### BACKGROUND

Within increasing numbers and types of environments, autonomous vehicles travel through areas and/or along pathways that are shared with other vehicles and/or pedestrians. Such other vehicles can include other autonomous vehicles, semi-autonomous vehicles, and/or manually operated vehicles. Autonomous vehicles can take a variety of forms and can be referred to using various terms, such as mobile robots, robotic vehicles, automated guided vehicles, and/or autonomous mobile robots (AMRs). In some cases, these vehicles can be configured for operation in an autonomous mode where they self-navigate or in a manual mode where a human directs the vehicle's navigation. Herein, vehicles that are configured for autonomous navigation are referred to as AMRs.

Multiple AMRs may have access to an environment and both the state of the environment and the state of an AMR can be constantly changing. The environment can be within, for example, a warehouse or large storage space or facility and the AMRs can include, but are not limited to, pallet lifts, pallet trucks, and tuggers.

Industrial AMRs, such as those that operate in warehouse environments, need to sense objects that they are manipulating or with which they otherwise interface. Broadly and collectively, these objects can be referred to as instances of “industrial infrastructure.” Concrete examples of such industrial infrastructure include, but are not limited to, pallets, racks, conveyors, tables, tugger carts, and charging stations.

Within such environments, navigable paths may exist enabling AMRs, and others, to drop off and pick up locations that serve as destinations and/or waypoints within the environment. A staging lane may be a stop on the AMR's path where a load it picked up or dropped off. When entering a staging lane, autonomous vehicles will commonly have to perform de-stacking, that is, pick a load off of other loads.

In various instances, therefore, the AMRs interact with stacked towers of pallets with unknown heights. The AMR and/or load engagement system needs to be able to assess and find the topmost load/pallet in the stack. Inputs from a warehouse management system (WMS) or static assumptions about how many loads are in a stack can result in errors (e.g., being off by one, humans interacting with the stack without the system's knowledge, etc.) which can result in serious safety concerns, such as accidentally picking up more than one pallet/load at a time.

### SUMMARY OF THE INVENTION

In accordance with a general aspect of the inventive concepts, provided is an autonomous mobile robot (AMR), including a chassis; a navigation system configured to navigate the AMR to stacked infrastructures; at least one sensor, including a payload presence sensor configured to perform a vertical scan of the stacked infrastructures; and at least one processor. The at least one processor is configured to estimate a height of the stacked infrastructures using data generated by the payload presence sensor, and estimate a height of a target infrastructure using the estimated height of the stacked infrastructures and expected infrastructure heights.

In various embodiments, the stacked infrastructures comprise a plurality of pallets and payloads on the pallets.

In various embodiments, the payload presence sensor is mounted to a backrest of the AMR.

In various embodiments, the payload presence sensor includes one or more of 2D LiDAR sensors and/or physical paddle sensors.

In various embodiments, a height of the stacked infrastructures is estimated by a height stack estimation algorithm.

In various embodiments, the height estimation algorithm forms a volume of interest surrounding a face of the stacked infrastructures.

In various embodiments, the height estimation algorithm is configured to output at least one of a stack height and a number of payloads.

In various embodiments, the height estimation algorithm extracts a plurality of measurement points in the volume of interest.

In various embodiments, the height estimation algorithm sorts the plurality of measurement points.

In various embodiments, the height estimation algorithm iterates through the plurality of measurement points and accumulates a height difference of a current point from a previous point into an accumulated height.

In various embodiments, the height of the target infrastructure is estimated based on a height stack estimation algorithm.

In various embodiments, the payload presence sensor utilizes a point cloud to form a 3D evidence grid of space.

In various embodiments, the AMR further comprises a communication module configured to communicate with a supervisor. In accordance with another aspect of the inventive concepts, provided is a method for localizing infrastructure, including providing an autonomous mobile robot (AMR), comprising at least one processor and at least one sensor including a payload presence sensor configured to perform a vertical scan of stacked infrastructures; estimating a height of the stacked infrastructures using data generated by the payload presence sensor; and estimating a height of a target infrastructure using the estimated height of the stacked infrastructures and expected infrastructure heights.

In various embodiments, the stacked infrastructures comprise a plurality of pallets and payloads on the pallets.

In various embodiments, the payload presence sensor includes one or more of 2D LiDAR sensors, 3D LiDAR sensors, and/or physical paddle sensors.

In various embodiments, the method further includes estimating a height of the stacked infrastructures using a height stack estimation algorithm. In various embodiments, the method further comprises obtaining a plurality of LiDAR measurement points.

In various embodiments, the method further comprises forming a point cloud using the plurality of lidar measurement points.

In various embodiments, the method further comprises sorting the plurality of LiDAR measurement points.

In various embodiments, the method further comprises iterating through the plurality of LiDAR measurement points and accumulating a height difference of a current point from a previous point into an accumulated height.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. In the drawings:

FIG. 1 is a perspective view of an embodiment of an AMR lift truck that is equipped and configured to drop off and pick up objects, in accordance with aspects of the inventive concepts.

FIG. 2A is another perspective view of the AMR lift truck of FIG. 1.

FIG. 2B provides a side view of a robotic vehicle with its load engagement portion extended, in accordance with aspects of inventive concepts.

FIG. 3 is a block diagram of an embodiment of an AMR, in accordance with aspects of the inventive concepts.

FIGS. 4A and 4B are diagrams of an embodiment of an AMR performing a detection and localization of a payload.

FIG. 5 is a flow diagram of an embodiment of a method of an AMR for dynamically determining a height of a payload in a payload stack, in accordance with aspects of the inventive concepts

FIG. 6 is a flow diagram of an embodiment of a height stack estimation algorithm, in accordance with aspects of the inventive concepts.

FIG. 7 is a flow diagram of an embodiment of a stack height calculation, in accordance with aspects of the inventive concepts.

### DESCRIPTION OF PREFERRED EMBODIMENT

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

To the extent that functional features, operations, and/or steps are described herein, or otherwise understood to be included within various embodiments of the inventive concepts, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

When depleting lane grids, AMRs will commonly have to deal with stacked towers of pallets with unknown heights. At runtime, the system needs to be able to assess and dynamically find the topmost load/pallet in the stack. This problem needs to be solved dynamically with measurement because it is not sufficient to trust WMS input or static assumptions about how many loads are in a stack: errors (off by one, humans interacting with the stack without the system's knowledge, etc) can result in serious safety concerns, such as accidentally picking up more than one pallet/load at a time.

The present inventive concepts provide a method of dynamic, real-time sensing of the actual environment as opposed to trusting application priors (e.g., WMS inputs).

According to the present inventive concepts, the AMR enters a lane and traverses down it until it finds an obstacle in front of it. The AMR uses existing methods to verify the obstacle is, in fact, a pallet or pickable object. At this point, the vehicle will invoke an algorithm which leverages data from a payload presence sensor, for example, a carriage-mounted planar lidar scanner (rotated 90 degrees so the scanning plane is vertical) to measure the height of the stack directly in front of the vehicle. The system then uses this measurement (in combination with inputs about expected payload heights in the stack) to estimate the expected height of the top pallet (payload) in the stack. The vehicle raises to this estimated height, uses existing pallet scanning technology to verify the pose of the pallet, and engages with the pallet (if it is found at the expected height within a small tolerance).

The present inventive concepts provide a perception algorithm for measuring stack height based on the rotated planar lidar combined with application logic to find the actual position of the expected pallet based on the stack height.

The present inventive concepts provide using application logic to sanity-check that the pallet that is found is actually the expected pallet.

The present inventive concepts provide a system with the ability to ‘steer’ pallet detection logic toward the top-most or bottom-most pallet in the field of view based on application logic.

The present inventive concepts provide a system including application logic which decides whether or not the vehicle is de-stacking.

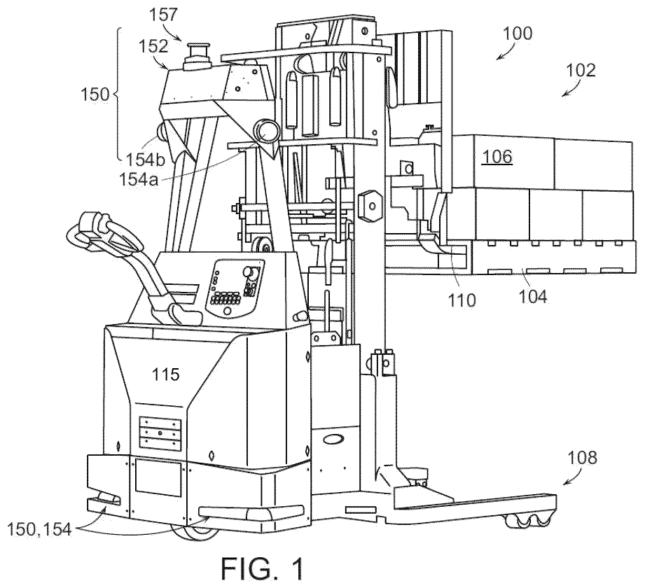

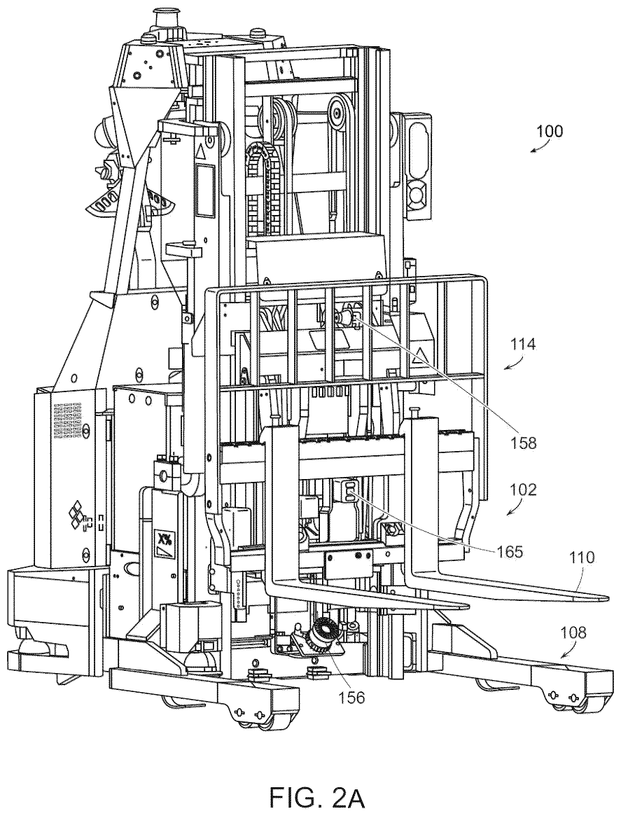

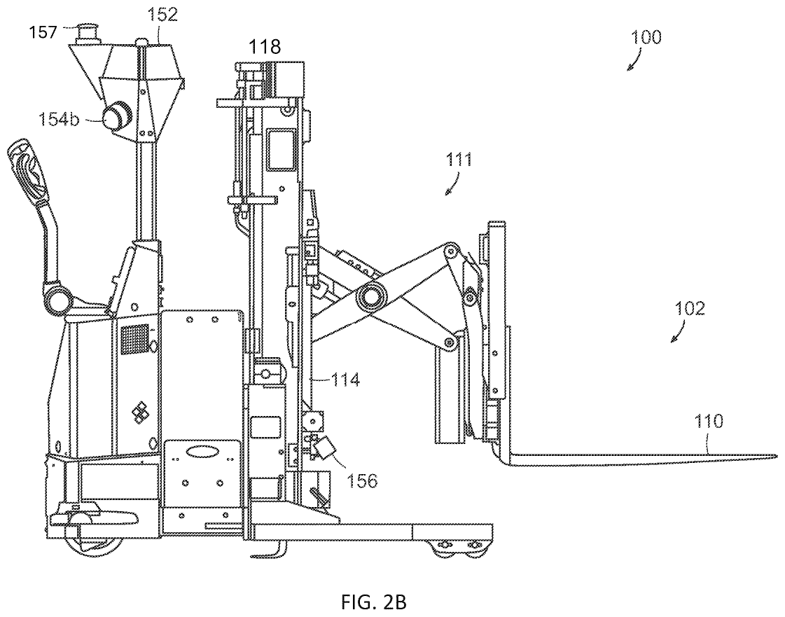

Referring to FIGS. 1, 2A and 2B, shown is an example of a self-driving or robotic vehicle in the form of an AMR lift truck 100 that is equipped and configured to drop off and pick up objects, such as palletized loads or other loads, in accordance with aspects of the inventive concepts. Although the robotic vehicle can take the form of an AMR lift truck 100, the inventive concepts could be embodied in any of a variety of other types of robotic vehicles and AMRs, including, but not limited to, forklifts, tow tractors, tuggers, and the like.

In this embodiment, the AMR 100 includes a chassis configured to provide structural framework of the vehicle and is a base on which the body of the AMR 100 is built.

In this embodiment, AMR 100 includes a payload area 102 configured to transport any of a variety of types of objects that can be lifted and carried a pair of forks 110. Such objects can include a pallet 104 loaded with goods 106, collectively a “palletized load,” or a cage or other container with fork pockets, as examples. Outriggers 108 extend from the robotic vehicle 100 in the direction of forks 110 to stabilize the AMR, particularly when carrying palletized load 104, 106.

Forks 110 may be supported by one or more robotically controlled actuators coupled to a carriage 114 that enable AMR 100 to raise and lower, side-shift, and extend and retract to pick up and drop off objects in the form of payloads, e.g., palletized loads 104, 106 or other loads to be transported by the AMR. In various embodiments, the AMR may be configured to robotically control the yaw, pitch, and/or roll of forks 110 to pick a palletized load in view of the pose of the load and/or horizontal surface that supports the load. In various embodiments, the AMR may be configured to robotically control the yaw, pitch, and/or roll of forks 110 to pick a palletized load in view of the pose of the horizontal surface that is to receive the load.

AMR 100 may include a plurality of sensors 150 that provide various forms of sensor data that enable the AMR to safely navigate throughout an environment, engage with objects to be transported, and avoid obstructions. In various embodiments, the sensor data from one or more of sensors 150 can be used for path navigation and obstruction detection and avoidance, including avoidance of detected objects, hazards, humans, other robotic vehicles, and/or congestion during navigation.

One or more of sensors 150 can form part of a two-dimensional (2D) or three-dimensional (3D) high-resolution imaging system used for navigation and/or object detection. In some embodiments, one or more of the sensors can be used to collect sensor data used to represent the environment and objects therein using point clouds to form a 3D evidence grid of the space, each point in the point cloud representing a probability of occupancy of a real-world object at that point in 3D space.

In computer vision and robotic vehicles, a typical task is to identify specific objects in a 3D model and to determine each object's position and orientation relative to a coordinate system. This information, which is a form of sensor data, can then be used, for example, to allow a robotic vehicle to manipulate an object or to avoid moving into the object. The combination of position and orientation is referred to as the “pose” of an object. The image data from which the pose of an object is determined can be either a single image, a stereo image pair, or an image sequence where, typically, the camera as a sensor 150 is moving with a known velocity as part of the robotic vehicle.

Sensors 150 can include one or more stereo cameras 152 and/or other volumetric sensors, sonar sensors, radars, and/or LiDAR scanners or sensors 154a, 154b positioned about AMR 100, as examples. Inventive concepts are not limited to particular types of sensors, nor the types, configurations, and placement of the AMR sensors in FIGS. 1, 2A and 2B. In some embodiments, object movement techniques (i.e., dropping an object in the zone, removing an object from a zone) described herein are performed with respect to one or more of sensors 150, in particular, a combination of object detection sensors and load presence sensors. The object detection sensor(s) is/(are) configured to locate a position of an object withing the zone. An object detection sensor can be or include at least one camera, LiDAR, electromechanical, and so on. The load presence sensor(s) is/(are) configured to determine whether AMR 100 is carrying an object.

In the embodiment shown in FIG. 1, at least one of LiDAR devices 154a, b can be a 2D or 3D LiDAR device for performing safety-rated forward obstruction sensing functions. In alternative embodiments, a different number of 2D or 3D LiDAR devices are positioned near the top of AMR 100. Also, in this embodiment a LiDAR 157 is located at the top of the AMR. In some embodiments LiDAR 157 is a 2D LiDAR used for localization or odometry-related operations.

The object detection and load presence sensors can be used in combination with others of the sensors, e.g., stereo camera head 152. Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

As shown in FIG. 2A, AMR 100 includes three particular sensors 156, 158, and 165 (which may be among the sensors 150) that collect sensor data used in determining where to perform either a payload acquisition or deposition within a zone without prior knowledge or training of the location of objects within the zone.

Payload presence sensor 158 may perform 2D LiDAR operations, 3D LiDAR operations, or the like to perform a load presence sensing operation. In some embodiments, payload presence sensor 158 may be a physical paddle sensor or other sensor type to detect whether or not a load is being transported by the AMR, e.g., whether a load present on the forks. Payload presence sensor 158 can be used during picks to determine when to stop moving the forks 110 in order to avoid pushing a pallet or other object along the floor into other objects. 2D LiDAR sensors are conventionally used as safety scanners sweeping horizontally near to the ground to detect the presence of obstacles. The payload presence sensor 158 may be a 2D LiDAR sensor rotated 90 degrees and mounted to the AMR 100 so the plane is vertical in order to measure the height of the stack directly in front of the vehicle. The payload presence sensor 158 may be positioned on a backrest of the AMR 100. In some embodiments, the payload presence sensor 158 can comprise one or more 3D LiDAR sensors. In some embodiments, the payload presence sensor 158 can be configured to utilize a point cloud to form a 3D evidence grid of space. The payload presence sensor can also be configured to determine whether a pallet 104 and/or payload 106 is within a volume of interest

The object of interest detection sensor 156 can perform object of interest detection and/or reverse obstruction sensing functions. The object of interest detection sensor 156 can be coupled to carriage 114 or other movable portion of AMR 100 so that sensor 156 moves with the forks. Sensor 156 can be mounted to a payload engagement structure of lift mast 118 to which carriage 114, or other AMR component, is movably attached that allows the sensor 156 to move vertically with the forks 110, i.e., pair of forks (or tines), that engage and disengage from a palletized load, or payload. Object of interest detection sensor 156 is obscured behind forks 110 when they are lowered to a floor height, in this embodiment. Object of interest detection sensor 156 is used to find objects in the region of interest that AMR 100 needs to stop next to-either to deposit a payload in the “drop” case or for the purpose of positioning an object of interest classification sensor 165 to be able to detect the object in the “pick” case. In some embodiments, object of interest detection sensor 156 may perform 3D LiDAR operations. In other embodiments, object of interest detection sensor 156 performs 2D LiDAR operations, but is not limited thereto these implementations, so long as object of interest detection sensor 156 can determine or sense a position of an object on the floor in a region of interest. In some embodiments, object of interest classification sensor 165, also referred to as a pallet detection sensor in the case of a forklift or lift truck, is arranged to determine the pose of a pickable object, such as a pallet, cage, container, or the like that have slots or pockets to receive forks 110 of AMR 100.

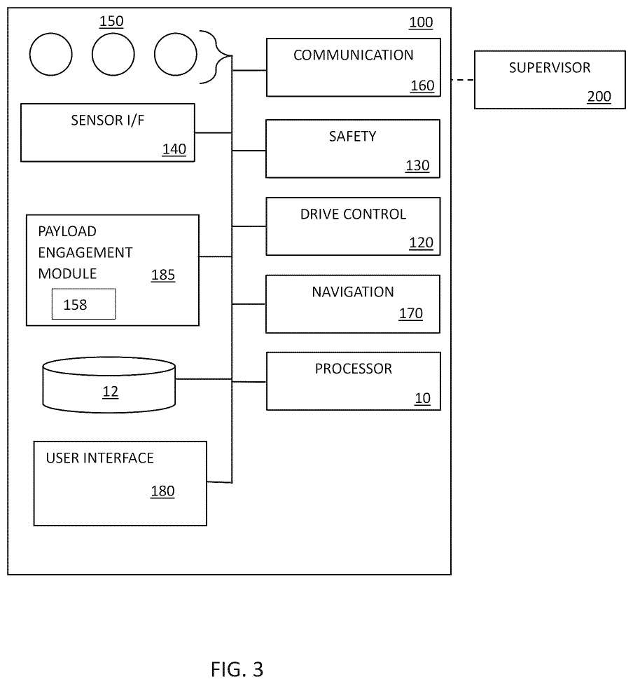

Object of interest classification sensor 165 may include a camera or the like to verify that the object being detected is a payload that the AMR can acquire. Other sensors in lieu of a camera may be used. In some embodiments, one or more sensors can communicate with the payload engagement system (see FIG. 3) to determine both if the object is one that can be acquired by forks 110 of AMR 100, and the pose of that object relative to AMR 100. The pose indicates an orientation of the object, e.g., pallet, at the location within the zone and is useful for the AMR in determining whether it can align the forks to safely pick the object. Therefore, in some embodiments, the object of interest classification sensor 165 determines if an object is pickable. For example, sensor 165 may send images to the payload engagement module 185 to determine if an object can be engaged by forks 100, such as a pallet, cage, container, or the like that have slots or pockets to receive forks 110 of AMR 100.

FIG. 2B provides a side view of a robotic vehicle with its load engagement portion extended, in accordance with aspects of inventive concepts. As is shown, the forks 110 may be supported by one or more robotically controlled actuators 111 coupled to a carriage 114 that enable the robotic vehicle 100 to raise and lower and extend and retract to pick up and drop off loads, e.g., palletized loads 106. In various embodiments, the robotic vehicle may be configured to robotically control the yaw, pitch, and/or roll of the forks 110 to pick a palletized load in view of the pose of the load and/or horizontal surface that supports the load. In various embodiments, the robotic vehicle may be configured to robotically control the yaw, pitch, and/or roll of the forks 110 to pick a palletized load 106 in view of the pose of the horizontal surface that is to receive the load.

FIG. 3 is a block diagram of components of an embodiment of AMR 100 of FIGS. 1, 2A and 2B, incorporating technology for moving and/or transporting objects (e.g., loads or pallets) to/from a predefined zone, in accordance with principles of inventive concepts. The embodiment of FIG. 3 is an example; other embodiments of AMR 100 can include other components and/or terminology. In the example embodiment shown in FIGS. 1-3, AMR 100 is a warehouse robotic vehicle, which can interface and exchange information with one or more external systems, including a supervisor system, fleet management system, and/or warehouse management system (collectively “supervisor 200”). In various embodiments, supervisor 200 could be configured to perform, for example, fleet management and monitoring for a plurality of vehicles (e.g., AMRs) and, optionally, other assets within the environment. Supervisor 200 can be local or remote to the environment, or some combination thereof.

In various embodiments, supervisor 200 can be configured to provide instructions and data to AMR 100, and to monitor the navigation and activity of the AMR and, optionally, other AMRs. The AMR can include a communication module 160 configured to enable communications with supervisor 200 and/or any other external systems. Communication module 160 can include hardware, software, firmware, receivers, and transmitters that enable communication with supervisor 200 and any other external systems over any now known or hereafter developed communication technology, such as various types of wireless technology including, but not limited to, Wi-Fi, Bluetooth™, cellular, global positioning system (GPS), radio frequency (RF), and so on.

As an example, supervisor 200 could wirelessly communicate a path for AMR 100 to navigate for the vehicle to perform a task or series of tasks. The path can be relative to a map of the environment stored in memory and, optionally, updated from time-to-time, e.g., in real-time, from vehicle sensor data collected in real-time as AMR 100 navigates and/or performs its tasks. The sensor data can include sensor data from one or more sensors described with reference to FIGS. 1, 2A and 2B. As an example, in a warehouse setting the route could include a plurality of stops along a route for the picking and loading and/or the unloading of objects, e.g., payload of goods. The route can include a plurality of path segments, including a zone for the acquisition or deposition of objects. Supervisor 200 can also monitor AMR 100, such as to determine the AMR's location within the environment, battery status and/or fuel level, and/or other operating, vehicle, performance, and/or load parameters.

As described above, a route may be developed by training AMR 100. That is, an operator may guide AMR 100 through a travel path within the environment while the AMR, through a machine-learning process, learns and stores the route for use in task performance and builds and/or updates an electronic map of the environment as it navigates, with the route being defined relative to the electronic map. The route may be stored for future use and may be updated, for example, to include more, less, or different locations, or to otherwise revise the travel route and/or path segments, as examples.

As is shown in FIG. 3, in example embodiments, AMR 100 includes various functional elements, e.g., components and/or modules, which can be housed within housing 115. Such functional elements can include at least one processor 10 coupled to at least one memory 12 to cooperatively operate the vehicle and execute its functions or tasks. Memory 12 can include computer program instructions, e.g., in the form of a computer program product, executable by processor 10. Memory 12 can also store various types of data and information. Such data and information can include route data, path data, path segment data, pick data, location data, environmental data, and/or sensor data, as examples, as well as the electronic map of the environment. In some embodiments, memory 12 stores relevant measurement data for use by a payload engagement module 185 that exchanges information with the sensors, in particular, object detection sensor 156, load presence sensor 158, and object of interest classification sensor 165 of FIGS. 1, 2A and 2B and, using the sensors 156, 158, 165, determines a location of an object within a predefined zone in order to determine where to perform a deposition in a load drop mode and a removal in a load engagement mode within the zone.

In this embodiment, processor 10 and memory 12 are shown onboard AMR 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of AMR 100 can further include a navigation module 170 configured to access environmental data, such as the electronic map, and path information stored in memory 12, as examples. Navigation module 170 can communicate instructions to a drive control subsystem 120 to cause AMR 100 to navigate its route by navigating a path within the environment. During vehicle travel, navigation module 170 may receive information from one or more sensors 150, via a sensor interface (I/F) 140, to control and adjust the navigation of the AMR. For example, sensors 150, 156, 158, 165, etc. may provide 2D and/or 3D sensor data to navigation module 170 and/or drive control subsystem 120 in response to sensed objects and/or conditions in the environment to control and/or alter the AMR's navigation. As examples, sensors 150, 156, 158, 165, etc. can be configured to collect sensor data related to objects, obstructions, equipment, goods to be picked, hazards, completion of a task, and/or presence of humans and/or other robotic vehicles. An object can be a pickable or non-pickable object within a zone used by the vehicle, such as a palletized load, a cage with slots for forks at the bottom, a container with slots for forks located near the bottom and at the center of gravity for the load. Other objects can include physical obstructions in a zone, such as a traffic cone or pylon, a person, and so on.

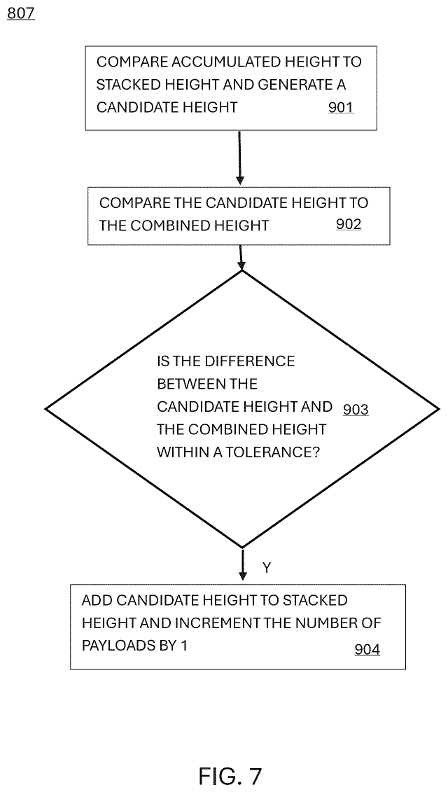

The AMR may also include a graphical user interface (GUI) module 180 or other display for human user interaction, for example, see display 700 shown in FIG. 7, that is configured to receive human operator inputs, e.g., a pick or drop complete input at a stop on the path. Other human inputs could also be accommodated, such as inputting map, path, and/or configuration information. In various embodiments, the GUI module 180 can be used to build a route and define and/or determine a zone on the route, with an exit and/or entrance, a near bound, and a far bound.

A safety module 130 can also make use of sensor data from one or more of sensors 150, in particular, LiDAR scanners 154, to interrupt and/or take over control of drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

In various embodiments, payload engagement module 185 can process sensor data from one or more of the sensors 150, in particular, object of interest detection sensor 156, load presence sensor 158, and object of interest classification sensor 165 and generate signals to control one or more actuators that control AMR 100. For example, payload engagement module 185 can be configured to robotically control carriage 114 to pick and drop payloads. In some embodiments, payload engagement module 185 can be configured to control and/or adjust position and orientation of the load engagement portion of AMR 110, e.g., forks 110 and/or carriage 114. These adjustments can be based on, at least on part, a pose of the object to be picked.

As shown in FIGS. 1, 2A, 2B and 3, in various embodiments, the system can comprise a mobile robotics platform, such as an AMR, at least one sensor 150 configured to collect/acquire point cloud data, such as a LiDAR scanner or 3D camera; and at least one local processor 10 configured to process, interpret, and register the sensor data relative to a common coordinate frame. For example, scans from the sensor 150, e.g., LiDAR scanner or 3D camera, are translated and rotated in all six degrees of freedom to align to one another and create a contiguous point cloud. To do this, a transform is applied to the data. The sensor data collected by sensors 150 can represent objects using the point clouds, where points in a point cloud represent discrete samples of the positions of the objects in 3-dimensional space. AMR 100 may respond in various ways depending upon whether a point cloud based on the sensor data includes one or more points impinging upon, falling within an envelope of, or coincident with the 3-dimensional path projection (or tunnel) of AMR 100. In some embodiments, the point cloud can be utilized to determine the presence or absence of an object in a 3-dimensional space.

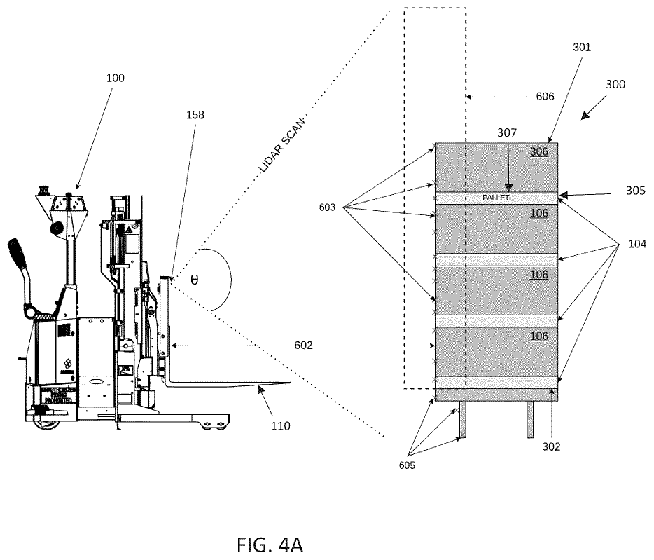

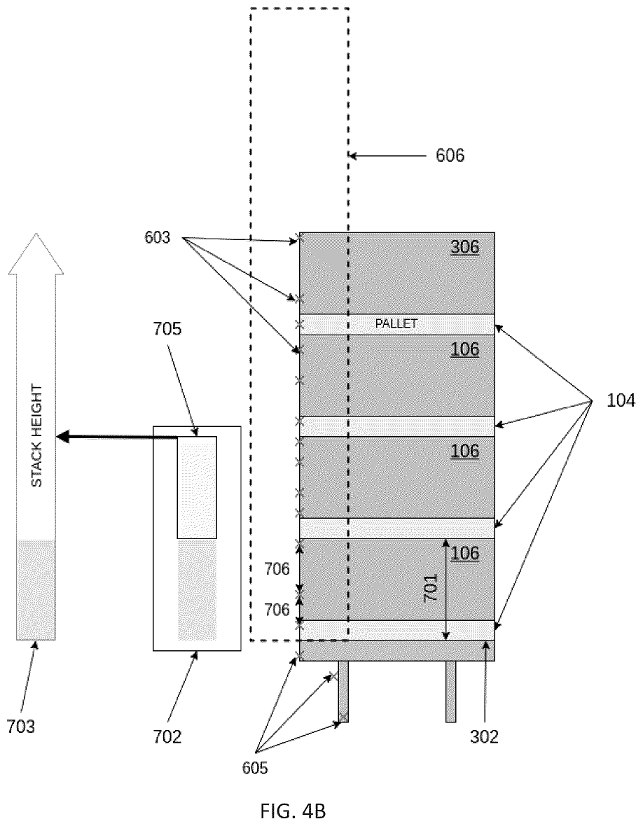

FIGS. 4A and 4B are diagrams of an embodiment of an AMR 100 configured to perform detection and localization of a payload that is part of a payload stack 300. A payload stack, for example, can take the form of or comprise a vertical stack of one or more pallets of goods. In FIGS. 4A and 4B, the payload stack 300 includes multiple palletized loads, each including a payload 106 on a pallet 104.

In the embodiment of FIGS. 4A and 4B, the payload presence sensor 158 of AMR 100 is a LiDAR scanner, that is conventionally used to perform a horizontal scan, rotated and/or reoriented and mounted to the AMR 100 in order to scan at an angle θ, which increases an angle of a scan plan produced by sensor 158 relative to the horizontal and/or ground surface. That is, the payload presence sensor 158 is a LiDAR scanner mounted sideways to the AMR 100 to perform a vertical scan, rather than a horizontal scan. In some embodiments, as examples, 0°<θ≤45°; 0°<θ≤75°; 0°<θ≤90°; or 0°<θ≤180°. In other embodiments, θ can be a different angle. In some embodiments, the sensor 158 can be rotated and/or otherwise reoriented to shift the scan plane to be more a vertical or substantially vertical scan plane. The angled scan produced by the payload presence sensor 158 allows the payload presence sensor 158 to scan vertically, preferably the entire height of a payload stack 300. In some embodiments, this can include the sensor 158 scanning from a top of the payload stack 301 to a bottom of the payload stack 302, and/or vice versa.

When detecting a target pallet 305, upon which is a target payload 306, with which the AMR 100 is tasked to engage using forks 110, the AMR 100 must be positioned in the right pose. That is, the AMR 100 must have, not only the right height of the target pallet 305, but also be in a proper positional orientation relative to the target pallet 305. The payload engagement module 185 uses the data from the payload presence sensor 158 to dynamically perform stack height estimation, e.g., a height at the top of the stack 301. The payload engagement module 185 subtracts the height of the payload 306 from the estimated stack height in order to determine the height of the target pallet 305 to be engaged by the forks 110. The difference in these heights can be referred to as a computed offset 307.

The payload engagement module 185 executes a stack height estimation algorithm which leverages data from payload presence sensor 158 to measure the height of the stack 300 directly in front of the vehicle. The system then uses this measurement (in combination with input about expected payload height, for example, provided by the WMS) to estimate the expected height of the top pallet 305 in the stack 300.

The stack height estimation algorithm requires the following parameters to be configured: the maximum stack height the AMR 100 can unstack, the stack height tolerance, the payload height tolerance, and the bounding box offsets.

Referring to FIGS. 4A and 4B, the stack height estimation algorithm requires the following input parameters which are provided per request to scan the payload: the combined height 701 of the payload 106 and pallet 104, the height 302 to the bottom of the stack, and the expected longitudinal position 602 of stack 300 in front of the payload presence sensor 158.

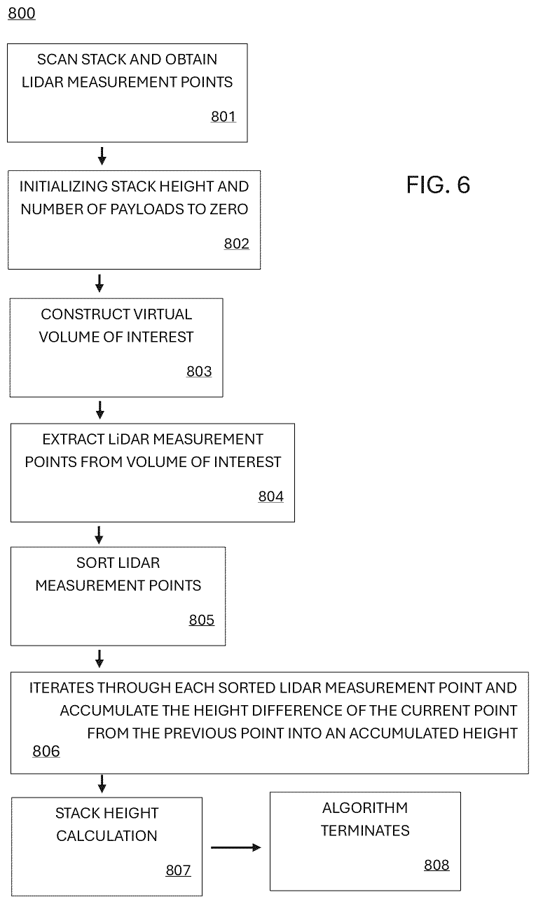

FIG. 6 is a flow diagram of an embodiment of a height stack estimation algorithm, in accordance with aspects of the inventive concepts.

Referring to FIG. 6, the stack height estimation algorithm can output: the stack height 703 and the number of payloads in the stack.

While the stack in FIGS. 4A and 4B are illustrated on an infrastructure, for example, a table, the present inventive concepts are not limited thereto. In some embodiments, the height 302 to the bottom of the stack can be zero. That is, in some embodiments the stack is positioned on the floor.

At block 810, Once a request to scan the stack has been received, the stack height estimation algorithm performs the following steps 800. This sequence of steps can be performed in any combination and should not be construed as limited by the order in which they are presented herein. At block 801, sensor 158 is used to scan payload stack 300 and obtain lidar measurement points 603 and 605. In some embodiments, the sensor 158 obtains only LiDAR measurement points 603.

At block 802, the value of stack height 703 and the number of payloads are initialized to 0.

At block 803, the algorithm constructs a virtual volume of interest 606 surrounding the payload stack face using height 302, expected longitudinal position 602, and bounding box offsets.

At block 804, lidar measurement points 603 are extracted from the volume of interest 606. The LiDAR measurement points 603 relate to points within a volume of interest, and the LiDAR measurement points 605 relate to points outside a volume of interest. In some embodiments, the algorithm comprises a classification step distinguishing LiDAR measurement points 603 from LiDAR measurement points 605.

At block 805, the lidar measurement points 603 are sorted in an ascending order from the lowest height value to the greatest. At block 806, the algorithm iterates through each sorted lidar measurement point 603 and accumulates the height difference 706 of the current point from the previous point into the accumulated height 702. In some embodiments, the accumulated height can be determined by calculating the range of the LiDAR measurement points 603.

At block 807, the stack height is calculated. FIG. 7 is a flow diagram of an embodiment of a stack height calculation, in accordance with aspects of the inventive concepts.

At block 901, the accumulated height 702 is compared with the stack height 703 and a candidate height is generated which is the difference between the accumulated height 702 and the stack height 703. At block 902, the candidate height 705 is compared with the combined height 701. At block 903, it is determined if the difference between the candidate height 705 value and the combined height 701 of the payload 106 and pallet 104 is within the payload height tolerance. If the difference is determined to be within the payload height tolerance at block 904, the candidate height 705 is added to stack height 703 and the number of payloads is incremented by 1.

At block 808, the algorithm terminates when there are no more points; or the difference in height value between the previous point and current point is greater than the combined height 701 of the payload 106 and pallet 104, or the stack height 703 is greater than the maximum stack height.

Once the position of the target pallet 305 is determined and the pose is determined to be acceptable for picking the target pallet 305, the AMR raises the forks 110 to the height of the target pallet, uses the existing pallet scanning technology to verify the pose of the target pallet 305, and engages the forks 110 with the target pallet 305 (if it is found at the expected height within a small tolerance).

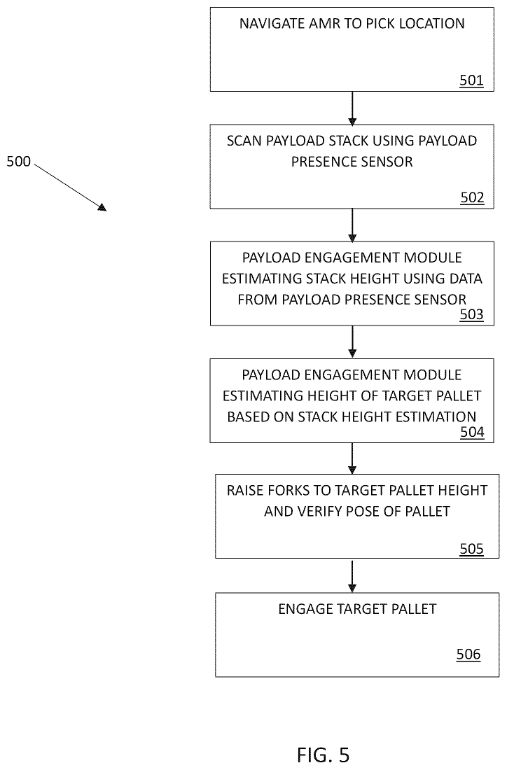

FIG. 5 is a flow diagram of an embodiment of a method of an AMR for dynamically determining a height of a payload in a payload stack, in accordance with aspects of the inventive concepts.

Using the payload engagement module 185 and other components of the AMR 100, FIG. 5 describes an embodiment of a method 500 for dynamically determining a height of a payload in a payload stack. Referring to method 500 illustrated in FIG. 5, the sensor 158 of an AMR 100 shown in FIGS. 1-3 can be used to determine a height of a payload in a payload stack.

At block 501, the AMR navigates to the pick location. At block 502, the payload presence sensor 158 which is positioned on the AMR 100 to provide a non-horizontal scan plan, which can be vertical or close to vertical, scans the payload stack.

At block 503, the payload engagement module 185 estimates the height of the payload stack using data from the payload presence sensor 158 and the stack height estimation algorithm as illustrated in FIGS. 6 and 7. At block 504, the payload engagement module 185 estimates the height of the target pallet 305 based on the stack height estimation and the expected or known height of the payload 306. The payload engagement module 185 subtracts the height of the payload 306 from the estimated height of the stack 300 in order to determine the height of the target pallet 305.

At block 505, the AMR raises the forks 110 to the target pallet 305 and verifies the pose of the pallet using existing pallet scanning technology. If the pose of the pallet is verified, that is, the detected pallet is within an application tolerance, at block 506, the AMR engages the target pallet with forks 110. For example, to engage the target pallet, the AMR extends its forks 110, using actuators 111 (see FIG. 2B) into pockets of the pallet. Then the AMR 100 lifts the target pallet 305 off of the stack 300, moves away from the stack, and can them lower the forks to ground level to transport the target pallet and its payload 306 to another location. If the detected pallet is not within an application tolerance, the system will enter a recoverable error state in which it will yield to the WMS to determine how to proceed, for example, sit and wait for a human to assist or get dispatched to perform an alternative operation. In some embodiments, the application tolerance is a predetermined range of variation within an expected pose of a pallet 104.

While the foregoing has described what are considered to be the best mode and/or other preferred embodiments, it is understood that various modifications may be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can combined in any given way.

Below follows an itemized list of statements describing embodiments in accordance with the inventive concepts:
1. An autonomous mobile robot (AMR), comprising:
   a chassis;
   a navigation system configured to navigate the AMR to stacked infrastructures comprising a target infrastructure;
   at least one sensor including a payload presence sensor configured to perform a vertical scan of the stacked infrastructures; and
   at least one processor configured to:
      estimate a height of the stacked infrastructure using data generated by the payload presence sensor, and
      estimate a height of the target infrastructure using the estimated height of the stacked infrastructures and expected infrastructure heights.
2. The AMR of claim 1, wherein the stacked infrastructures comprise a plurality of pallets and payloads on the pallets.
3. The AMR of claim 1, wherein the payload presence sensor includes one or more of 2D LiDAR sensors, 3D LiDAR sensors, and/or physical paddle sensors.
4. The AMR of claim 1, wherein the height of the stacked infrastructures is estimated by a height stack estimation algorithm.
5. The AMR of claim 4, wherein the height estimation algorithm forms a volume of interest surrounding a face of the stacked infrastructures.
6. The AMR of claim 4, wherein the height estimation algorithm is configured to output at least one of a stack height and a number of payloads.
7. The AMR of claim 5, wherein the height estimation algorithm extracts a plurality of measurement points in the volume of interest.
8. The AMR of claim 7, wherein the height estimation algorithm sorts the plurality of measurement points.
9. The AMR of claim 7, wherein the height estimation algorithm iterates through the plurality of measurement points and accumulates a height difference of a current point from a previous point into an accumulated height.
10. The AMR of claim 4, wherein the height of the target infrastructure is estimated based on the estimated height of the stacked infrastructure.
11. The AMR of claim 1, wherein the payload presence sensor utilizes a point cloud to form a 3D evidence grid of space.
12. The AMR of claim 1 further comprising a communication module configured to communicate with a supervisor.
13. A method for localizing infrastructure, comprising:
providing an autonomous mobile robot (AMR), comprising at least one processor and
at least one sensor including a payload presence sensor configured to perform a vertical scan of stacked infrastructures;
estimating a height of the stacked infrastructures using data generated by the payload presence sensor; and
estimating a height of a target infrastructure using the estimated height of the stacked infrastructures and expected infrastructure heights.
14. The method of claim 13, wherein the stacked infrastructures comprise a plurality of pallets and payloads on the pallets.
15. The method of claim 13, wherein the payload presence sensor includes one or more of 2D LiDAR sensors, 3D LiDAR sensors, and/or physical paddle sensors.
16. The method of claim 13, further comprising estimating a height of the stacked infrastructures using a height stack estimation algorithm.
17. The method of claim 13 further comprising obtaining a plurality of LiDAR measurement points in a volume of interest.
18. The method of claim 17 further comprising forming a point cloud using the plurality of LiDAR measurement points.
19. The method of claim 17 further comprising sorting the plurality of LiDAR measurement points.
20. The method of claim 17 further comprising iterating through the plurality of LiDAR measurement points and accumulates a height difference of a current point from a previous point into an accumulated height.

What is claimed is:

1. An autonomous mobile robot (AMR), comprising:
a chassis;
a navigation system configured to navigate the AMR to stacked infrastructures comprising a target infrastructure;
at least one sensor including a payload presence sensor configured to perform a vertical scan of the stacked infrastructures; and
at least one processor configured to:
estimate a height of the stacked infrastructure using data generated by the payload presence sensor, and
estimate a height of the target infrastructure using the estimated height of the stacked infrastructures and expected infrastructure heights.

2. The AMR of claim 1, wherein the stacked infrastructures comprise a plurality of pallets and payloads on the pallets.

3. The AMR of claim 1, wherein the payload presence sensor includes one or more of 2D LiDAR sensors, 3D LiDAR sensors, and/or physical paddle sensors.

4. The AMR of claim 1, wherein the height of the stacked infrastructures is estimated by a height stack estimation algorithm.

5. The AMR of claim 4, wherein the height estimation algorithm forms a volume of interest surrounding a face of the stacked infrastructures.
The AMR of claim 4, wherein the height estimation algorithm is configured to output at least one of a stack height and a number of payloads.

7. The AMR of claim 5, wherein the height estimation algorithm extracts a plurality of measurement points in the volume of interest.

8. The AMR of claim 7, wherein the height estimation algorithm sorts the plurality of measurement points.

9. The AMR of claim 7, wherein the height estimation algorithm iterates through the plurality of measurement points and accumulates a height difference of a current point from a previous point into an accumulated height.

10. The AMR of claim 4, wherein the height of the target infrastructure is estimated based on the estimated height of the stacked infrastructure.

11. The AMR of claim 1, wherein the payload presence sensor utilizes a point cloud to form a 3D evidence grid of space.

12. The AMR of claim 1 further comprising a communication module configured to communicate with a supervisor.

13. A method for localizing infrastructure, comprising:
providing an autonomous mobile robot (AMR), comprising at least one processor and at least one sensor including a payload presence sensor configured to perform a vertical scan of stacked infrastructures;
estimating a height of the stacked infrastructures using data generated by the payload presence sensor; and
estimating a height of a target infrastructure using the estimated height of the stacked infrastructures and expected infrastructure heights.

14. The method of claim 13, wherein the stacked infrastructures comprise a plurality of pallets and payloads on the pallets.

15. The method of claim 13, wherein the payload presence sensor includes one or more of 2D LiDAR sensors, 3D LiDAR sensors, and/or physical paddle sensors.

16. The method of claim 13, further comprising estimating a height of the stacked infrastructures using a height stack estimation algorithm.

17. The method of claim 13 further comprising obtaining a plurality of LiDAR measurement points in a volume of interest.

18. The method of claim 17 further comprising forming a point cloud using the plurality of LiDAR measurement points.

19. The method of claim 17 further comprising sorting the plurality of LiDAR measurement points.

20. The method of claim 17 further comprising iterating through the plurality of LiDAR measurement points and accumulating a height difference of a current point from a previous point into an accumulated height.
